(19) United States
(12) Patent Application Publication
(10) Pub. No.: US 2022/0055580 A1
(43) Pub. Date: Feb. 24, 2022

(54) Lifting Device For Rotationally Moving A Motor Vehicle

(71) Applicant: Michael Traut, Bergrheinfeld (DE)

(72) Inventor: Michael Traut, Bergrheinfeld (DE)

(21) Appl. No.: 17/284,626

(22) PCT Filed: Mar. 4, 2019
(86) PCT No.: PCT/DE2019/100193

§ 371 Date: Oct. 27, 2021

(30) Foreign Application Priority Data
Oct. 16, 2018 (DE) PCT/DE2018/100850

(51) Int. Cl. B60S 9/205; B60G 17/005; B62D 57/02

(52) U.S. Cl. CPC B60S 9/205; B62D 57/02; B60G 17/005

(57) ABSTRACT

A lifting device (10) for moving a motor vehicle, comprising a support structure (100, 100a) suitable to be removably or firmly connected to a vehicle underbody of the motor vehicle, and at least one drive shaft (220) which is rotatably mounted on the support structure (100, 100a). The at least one drive shaft (220) is part of a rotary blade drive (200), which rotary blade drive (200) additionally comprises at least one drive motor (211) for rotating the drive shaft (220) about the axis of rotation (221) thereof, and at least one rotary blade (240), that is connected to the drive shaft (220) so as to be able to rotate about the axis of rotation (221) such that the rotary blade (240) can be supported on the ground and the motor vehicle can be lifted and/or moved as a result of the torque (M) acting along the drive shaft (220).

### BACKGROUND OF THE INVENTION

The invention relates to a lifting device for moving a motor vehicle, comprising a support structure which is suitable to be removably or firmly connected to the motor vehicle, particularly a vehicle underbody of the motor vehicle, and at least one drive shaft which is rotatably mounted on the support structure.

The invention also relates to a motor vehicle having such a lifting device and a support device for a lifting device having a drive shaft.

Motor vehicles are required not only in road traffic but also off paved roads, in open, sometimes impassable terrain for the transport of vehicle occupants and/or goods, but also for construction or rescue operations and/or for exploring the terrain. When driving off-road, it can happen that the wheels that are usually provided for moving the motor vehicle, may slip due to lack of traction, e.g. on muddy or sandy ground, but also on ice or snow, and can no longer move the vehicle. Particularly in the case of sand or mud, it can also happen that the wheels of the vehicle dig in, which means that movement is no longer possible. Another challenge when driving off-road is overcoming obstacles, e.g. a bump or edge. Depending on the height of the obstacle, crossing using the conventional wheel drive is not possible at all, or the vehicle underbody may touch down when attempting to cross the obstacle, as a result of which the motor vehicle is stuck on the obstacle and cannot be moved any further.

Lifting devices for motor vehicles are already known from the prior art, which are intended to free the vehicle from such a state or a similar state in which the vehicle is stuck in or on the ground. In this case, the vehicle is usually lifted by means of hydraulic cylinders from the lowered (operating) position in which the vehicle contacts the ground with its wheels and is ready to drive, into a lifted position in which one, several or all of the wheels no longer touch the ground.

For example, a supporting steering device and a running device for a motor vehicle are known from CN 103 434 498. The supporting steering device comprises a hydraulic cylinder, the lower end of which is pivotably connected to a base plate for resting on the ground and the upper end of which is connected to a rotating plate arranged on the motor vehicle. As a result, the supporting steering device, if not in use, can be placed against the vehicle underbody and swiveled out if necessary, whereby the motor vehicle is lifted into a fully raised position in which all four wheels lose contact with the ground. The vehicle can then be rotated by 180° using the turntable, for example to perform a “U-turn.” The motor vehicle is additionally equipped with a running device which comprises four separate “feet” which are intended to enable running movement by pivoting several plates and arms about respective pivot axes that connect these to one another. Such “continuous” movement is, on the one hand, complicated in terms of control and almost impossible to achieve on uneven or slippery ground. Such a movement also leads to severe rocking of the motor vehicle, which reduces the comfort for the vehicle occupants.

Another way of freeing a vehicle from a stuck state is known from DE 26 06 399 A1. This document describes an all-terrain vehicle on the bottom side of which, that is, on the underbody of the vehicle, hydraulic cylinders designed as lifting cylinders are pivotably arranged. The hydraulic cylinders attached to the vehicle are intended to enable moving, supporting, and lifting the vehicle. According to a further exemplary embodiment, a plurality of hydraulic cylinders are arranged radially to the side of the vehicle on a shaft that is rotatably mounted on the vehicle body. This shaft is driven either by its own drive or by the vehicle drive itself. To move the vehicle, the shaft is rotated until one of the hydraulic cylinders is in an inclined position to the roadway. In this position, the shaft is unlocked from the drive via a coupling (not shown). The hydraulic cylinders are switched by means of a control device such that in this respective position the piston rod of the hydraulic cylinder can be extended and the vehicle can be moved. After the movement has taken place, the piston rod of the hydraulic cylinder is retracted, the shaft is rotated by a respective angle, and then the next hydraulic cylinder is pressurized to move the vehicle.

This process can be repeated any number of times until the vehicle has been moved in the desired manner. The lifting cylinders can be controlled automatically or manually from inside the vehicle. With the device described, however, actual or complete lifting of the off-road vehicle is not possible, as a result of which obstacles cannot be crossed. Movement by means of the radial hydraulic cylinders is also complex, since both a rotational movement of the shaft and a translational movement of the corresponding hydraulic cylinder are required. Finally, lateral movements or rotations of the vehicle are also not possible by means of the embodiments described.

Overall, the devices shown in the prior art are often not very reliable in use or are implemented in a complicated and costly manner, whereby particularly the small amount of space on the vehicle underbody is completely taken up and/or ground clearance is severely affected.

It is therefore the object of the present invention to overcome the disadvantages of the prior art and to create a lifting device for moving a motor vehicle, which particularly makes it possible to free the motor vehicle from a stuck state, to cross obstacles, and to further increase overall maneuverability.

### SUMMARY OF THE INVENTION

The object is achieved by a lifting device according to claim 1, a support device for a lifting device according to claim 21 and a motor vehicle with a lifting device according to claim 22.

A lifting device according to the invention of the type described in more detail at the outset is characterized in that the at least one drive shaft is part of a rotary blade drive, which rotary blade drive furthermore has at least one drive motor for rotating the drive shaft about the axis of rotation thereof, and at least one rotary blade, wherein the rotary blade is rotatable about the axis of rotation and connected to the drive shaft, such that the rotary blade can be supported on a ground and the motor vehicle can be lifted and/or moved forward as a result of a torque acting along the drive shaft.

According to the invention, therefore, a lifting device is provided which, particularly exclusively, can be permanently or removably connected to the motor vehicle, particularly to the underbody thereof, by means of a support structure. This allows retrofitting a motor vehicle with the lifting device according to the invention. Since the connection is designed to be detachable, the lifting device can also be variably mounted and dismantled as required or, in the event of a malfunction, removed or replaced for repair. The lifting device or its rotary blade drive(s) can be positioned, for example, on the front of the vehicle, on the rear of the vehicle, on the vehicle roof or on the hood, in a space-saving manner under the vehicle underbody and/or optionally within the vehicle interior or trunk, wherein the rotary blades in the latter case pass through specially designed body recesses to be supported on the ground. A drive shaft is rotatably mounted on the support structure, the drive shaft according to the invention being part of a rotary blade drive, that is, forming a component of a rotary blade drive. The rotary blade drive also includes a drive motor which is connected to the drive shaft in order to drive the same, i.e. to rotate or turn it about the axis of rotation thereof, optionally in a first direction of rotation or a second direction of rotation opposed to the first. Alternatively, the motor of the motor vehicle itself could also be used to drive the drive shaft. The drive motor can utilize various energy conversion principles, e.g. electrical, pneumatic, hydraulic, etc.

At least one rotary blade is firmly connected to the drive shaft, such that a rotation or turning of the drive shaft causes a simultaneous rotation of the rotary blade about the axis of rotation. The rotary blade can be fastened with a radially inner end or a connecting section at basically any position along the drive shaft and, starting from this position, extends radially in the direction of a radially outer end or a support edge. The length of the rotary blade is selected such that the rotary blade can be pivoted from a retracted position, towards the ground, into an extended position by rotating the drive shaft until the rotary blade comes into contact with the ground or its supporting edge rests on the ground. With further rotation, as a result of the torque acting along the drive shaft, a force is applied via the rotary blade supported on the ground, by means of which the motor vehicle can be lifted and/or moved. Depending on the direction of rotation, the motor vehicle is pulled or pushed along a longitudinal direction of the vehicle by the rotary blade or the rotary blade drive in the direction of rotation and simultaneously lifted, such that a rotationally driven movement takes place independently of the wheel drive.

It is advantageous in this case that the motor vehicle can move forward solely on the basis of the rotary drive, in that the at least one rotary blade is supported on the ground. Additional, translationally moved drive elements are not necessary just for moving and/or lifting the motor vehicle. By lifting and pushing or pulling the motor vehicle at the same time, it can be freed from a stuck state and/or the motor vehicle can be moved or lifted across obstacles. The motor vehicle can be moved a desired distance by the at least one rotary blade drive without the driver or the occupants having to leave the vehicle. The entire lifting device is designed to be flat for positioning below the vehicle underbody. In order to take up as little space as possible under the vehicle or to affect ground clearance as little as possible, the lifting device has a low overall height of preferably at most 5 cm.

Advantageous embodiments are claimed in the dependent claims and are explained in more detail below.

According to an advantageous embodiment, the at least one rotary blade can be rotated about the axis of rotation from a retracted position running parallel to the vehicle underbody into an extended position enclosing an angle with the vehicle underbody, preferably perpendicular to the vehicle underbody.

By rotating the rotary blade around the drive shaft from the retracted position to the extended position, the motor vehicle can thus be lifted from an operating position, in which the vehicle wheels contact the ground for movement by means of the wheel drive, into a lifted position, in which at least one of the vehicle wheels is lifted by means of the at least one rotary blade, particularly has no contact with the ground. The angle spanned between the vehicle underbody and the rotary blade is preferably approximately 90° in a completely extended position of the rotary blade, i.e. the rotary blade extends vertically with respect to the vehicle underbody in the direction of the ground. Partial lifting of the motor vehicle is thus already possible by means of a rotary blade drive with only one rotary blade.

In the operating position of the motor vehicle, it is advantageous to apply the at least one rotary blade in the retracted position in a flat orientation, that is, parallel to the vehicle underbody. particularly, the rotary blade is in a transport position below the vehicle floor, such that in this transport position the ground clearance is restricted as little as possible and the overall length of the motor vehicle is also not increased.

To move the motor vehicle, it is expedient to allow the at least one rotary blade to rotate completely around the drive shaft, i.e. by 360°, which is why, while moving, the at least one rotary blade or the drive shaft connected thereto is advantageously arranged in front of, behind, or to the side of the motor vehicle or the vehicle underbody with respect to the longitudinal direction of the vehicle in a drive position. In this way, a collision with the underbody of the vehicle can be avoided during the rotating movement.

In one embodiment of the invention, the at least one rotary blade advantageously has a radially inner rotary blade arm assigned to the drive shaft and a radially outer rotary blade arm assigned to the ground, wherein the radially inner rotary blade arm and the radially outer rotary blade arm are pivotally interconnected, such that the at least one rotary blade can be pivoted from a retracted position running parallel to the drive shaft into an extended position enclosing an angle with the drive shaft, preferably running perpendicular to the drive shaft.

This embodiment is particularly advantageous if the lifting device is mounted at the front of the vehicle and/or at the rear of the vehicle and the extended rotary blades would obstruct the driver's view through the front or rear window. During normal driving of the motor vehicle, the rotary blades can then be retracted at the front or rear of the vehicle parallel to the respective bumper.

Alternatively or in a further development of the above embodiment of the invention, at least one rotary blade comprises a radially inner rotary blade arm assigned to the drive shaft and a radially outer rotary blade arm assigned to the ground as well as a rotary blade arm section with one or more guide rails and guide slides assigned to the guide rails, such that an offset of the radially inner rotary blade arm relative to the radially outer rotary blade arm can be adjusted.

For example, the rotary blade arm section can have a cross rail and a lifting rail on which a cross slide or a lifting slide respectively slides in order to move the rotary blade arms relative to one another in additional spatial directions. This additional option of movement is particularly advantageous in connection with the previously described configuration of the pivotable rotary blades, since in this manner such an offset or overlapping of the rotary blades, particularly of the radially outer rotary blade arms, is made possible in the retracted position running parallel to the drive shaft and, at the same time, that the rotary blades, particularly the radially outer rotary blade arms, come to rest on the ground while the drive shaft is rotating.

The length of the rotary blade is expediently selected such that it is possible to lift at least one vehicle wheel even if the suspension or shock absorbers of the chassis of the motor vehicle are extended. Additionally or alternatively, it is also advantageous according to one embodiment if the lifting device has at least one spring lock, each spring lock being assignable to a suspension and/or a shock absorber of a vehicle wheel.

By means of the spring lock, which locks the suspension or the shock absorber of the chassis when the vehicle is lifted in a compressed position, i.e. in a compression caused by the vehicle weight, the achievable lifting height can be increased, for example, to overcome obstacles or to lift the vehicle out of a state in which the wheels have sunk particularly deep into the ground. Particularly, the spring lock comprises a servomotor or, in a technically simpler design, a linear actuator (e.g. electromagnet) which engages in, or presses against, a toothed rack connected to the shock absorber or the suspension by means of a servomotor gear or a toothed wedge. With the servomotor, the suspension or shock absorber can also be actively compressed, whereby the wheels compress further and the lifting height is additionally increased.

To improve maneuverability, an embodiment is advantageous in which the lifting device has at least one, particularly two, rotary blade drives, wherein each rotary blade drive is connected to the support structure by means of a respective drive shaft, and a front rotary blade drive is assigned to a vehicle's front axle and/or a rear rotary blade drive to a vehicle's rear axle.

Since each vehicle axle is preferably assigned to a rotary blade drive, the motor vehicle can be lifted completely, that is, none of the wheels contact the ground. To move the motor vehicle, the respective drive shafts are rotated in the same sense or direction of rotation, but for lifting purposes it is also conceivable to rotate the drive shafts in the opposite sense or direction of rotation.

An embodiment is particularly advantageous and can be used as standard in which each drive shaft has at least two rotary blades, and in which particularly one rotary blade is assigned to each vehicle wheel.

By expediently using four rotary blades, each of which being assigned to a vehicle wheel of the motor vehicle, the vehicle can be held level and secure against tipping over in the lifting position, particularly in the fully lifted position, particularly if the rotary blades are arranged in the extended position, preferably without contact between the ground and the vehicle wheels.

To further improve the maneuverability of the lifting device, a transverse wheel can be arranged on one, several, or all of the rotary blades according to an advantageous embodiment variant, which transverse wheel can be rolled on the ground to move the motor vehicle along a transverse direction of the vehicle and/or to rotate the motor vehicle about its vertical axis.

The respective transverse wheel is arranged obliquely, preferably transversely, i.e. vertically, to the alignment of the vehicle wheels and protrudes beyond the radially outer end of the rotary blade assigned to the ground or its supporting edge. By lifting the motor vehicle from the operating position into a lifted position, particularly a fully lifted position, by means of the at least one rotary blade, the at least one transverse wheel can come into contact with the ground and roll there. For this purpose, each transverse wheel can be assigned a transverse wheel drive which enables the respective transverse wheel to rotate in both directions of rotation. A total of four transverse wheels are preferably provided, two on the rotary blades assigned to the front and two on the rotary blades assigned to the rear wheel axle, such that a rotation of the front and rear transverse wheels in the same direction of rotation leads to a lateral movement of the motor vehicle along the vehicle transverse direction. Rotating the front and rear transverse wheels in opposite directions of rotation or applying different loads to the front and rear transverse wheel drives causes the motor vehicle to rotate about its vertical axis. In this way, the motor vehicle can, for example, be moved into tight parking spaces or achieve very narrow turning circles. It is also conceivable to make the transverse wheels themselves steerable.

According to a preferred embodiment, a stabilization device, which is provided for the lateral stabilization of the motor vehicle, is optionally arranged on one, several, or all of the rotary blades.

The respectively assigned stabilization device can preferably be extended along the support edge of the respective rotary blade from a retracted position to an extended position, which increases the overall length of the support edge along the transverse direction of the vehicle and thus improves the stability of the motor vehicle in the lifted position to avoid the risk of tipping over on uneven surfaces.

In a further, advantageous embodiment, it is also conceivable that a rotary blade support is arranged on one, several, or all of the rotary blades so as to be pivotable about a support edge of the rotary blade.

The respective rotary blade support is preferably plate-like and optionally connected to the support edge located at the radially outer end of the rotary blade by means of a cylindrical swivel joint or a ball joint, such that the rotary blade support aligns itself automatically following the force of gravity, running approximately parallel to the ground, provided the rotary blade is rotated from the retracted position into the extended position. The rotary blade support can serve to increase traction on very soft ground, particularly, to enlarge the support surface of the respective rotary blade with which the rotary blade is supported on the ground. Due to the pivotable articulated joint with the supporting edge, the rotary blade support takes up an optimal hold in a respective angular position even on uneven ground.

In a preferred embodiment of the invention, to make the lifting device more flexible and, for example, to adapt it to different vehicle types or different ground conditions, the one, several, or all of the rotary blades have a radially inner rotary blade arm assigned to the drive shaft and a radially outer rotary blade arm assigned to the ground, wherein the radially inner rotary blade arm and the radially outer rotary blade arm are radially displaceable relative to one another, whereby the radial length of the respective rotary blade is adjustable.

An adjustability of the radial length of a respective rotary blade can be configured manually, for example, wherein the radially inner rotary blade arm and the radially outer rotary blade arm each are provided with corrugated profiles designed for mutual engagement and arranged in different, radially offset positions and can be fixed by means of bolts or screws passing through respective holes. Alternatively, the rotary blade can be adjusted by means of an actuator driven electrically, hydraulically, pneumatically, or in some other way, wherein the rotary blade arms slide into one another via guide rails.

As explained at the outset, a complete rotation of the at least one rotary blade around the drive shaft, i.e. by 360°, is expedient for moving the motor vehicle, which is why the at least one rotary blade or the drive shaft connected thereto, can be arranged during the movement in a drive position in front of or behind the motor vehicle or the vehicle underbody with respect to the longitudinal direction of the vehicle.

To enable a change or a shift from the transport position, in which the rotary shovel and the drive shaft connected thereto are arranged, for example, in a position below the vehicle underbody, into the drive position and vice versa, the support structure according to an advantageous embodiment of the lifting device comprises guide rails and guide rods which are movable relative to each other along the vehicle longitudinal direction, wherein the guide rails are suitable for a removable or fixed connection to the underbody of the motor vehicle and the guide rods are connected to the at least one rotary blade drive, particularly indirectly by means of a drive carrier and/or the drive shaft of the rotary blade drive.

According to this embodiment, the guide rails are the only components of the lifting device which are connected, particularly immovably, to the vehicle underbody. The guide rails are preferably aligned along the longitudinal direction of the vehicle and the guide rods slide linearly within the guide rails, such that they can be moved back and forth, both relative to the guide rails and relative to the motor vehicle along the longitudinal direction of the vehicle. A first end of the respective guide rods directed towards the exterior of the vehicle is connected, particularly indirectly connected by means of various construction elements, particularly bearings for receiving the drive shaft, to a respective assigned rotary blade drive, such that the respective rotary blade drive can be extended from the transport position into the drive position relative to the vehicle underbody or relative to the motor vehicle through a relative movement of the guide rails and the guide rods to one another. The connection between the first end of a guide rod and the rotary blade drive is preferably implemented by means of a drive carrier of the rotary blade drive which carries the drive motor(s) and corresponding drive gears.

According to a preferred further development of this embodiment, the guide rails and the guide rods are connected to at least one linear actuator for movement relative to one another and along the longitudinal direction of the vehicle, wherein a first end section of the at least one linear actuator is connected to the guide rod and a second end section of the at least one linear actuator is connected to the guide rail.

The first end section of the at least one linear actuator can particularly be connected to a second end of a respective guide rod, located opposite the first end and facing the center of the vehicle, in order to move the guide rod and the rotary blade drive connected thereto out of the transport position towards the exterior of the vehicle into the drive position or to pull the rotary blade drive from the drive position towards the center of the vehicle into the transport position. The at least one linear actuator can be of various types, e.g. electrical, hydraulic, pneumatic, etc.

Particularly, if the lifting device or the rotary blade drive is arranged on the rear of the vehicle and/or on the front of the vehicle, behind or in front of the motor vehicle, it is advantageous according to an embodiment of the invention that the drive shaft for axial displacement of the at least one rotary blade along the axis of rotation thereof comprises an internal shaft connected to the drive motor and a hollow shaft connected to the at least one rotary blade and coaxially surrounding the internal shaft, wherein the internal shaft and the hollow shaft are movable relative to one another along the axis of rotation and are in a torque-transmitting operative connection with one another.

During normal driving, that is, when the motor vehicle is in its operating position, the rotary blade drives should in their transport position ideally not protrude beyond the lateral dimensions of the motor vehicle. In the lifting position of the motor vehicle and for movement by means of the lifting device or the rotary blade drives, however, the rotary blades should then be in a drive position to the side of the motor vehicle in order to enable a complete 360° rotation. To move the motor vehicle in the longitudinal direction of the vehicle by means of the lifting device, the rotary blades attached to the drive shaft are first moved axially from a transport position into a drive position located laterally next to the motor vehicle by means of an electrically, pneumatically, hydraulically, or otherwise driven linear actuator, and then set in rotation by means of the drive motor. The respective direction of rotation can be selected by the operator depending on the desired direction of movement. A torque-transmitting operative connection is implemented between the inner shaft and the hollow shaft, for example by means of a form-fitting engagement, the form-fit still permitting a relative axial movement. The drive shaft can also be designed telescopically, with multiple hollow shafts arranged coaxially with one another, to achieve greater axial displacement paths, that is, to extend the rotary blades by a greater distance in the axial direction. Due to the axial displaceability of the rotary blades, it is also possible for the motor vehicle to move laterally, that is, in the transverse direction of the vehicle. For this purpose, the rotary blades are first extended from the transport position into the drive position by means of the respective linear actuators on only one side of the vehicle, then the motor vehicle is lifted to a preferably fully lifted position by rotating the rotary blades on both sides of the vehicle. The motor vehicle can be moved laterally by axially retracting the extended rotary blades on one side of the vehicle and axially extending the retracted rotary blades on the other side of the vehicle. This function enables the motor vehicle to move sideways in the smallest of spaces, for example to get into tight parking spaces.

Optionally, the invention can be designed such that the guide rails and the guide rods and/or the inner shaft and the hollow shaft and/or the radially inner rotary blade arm and the radially outer rotary blade arm can be locked in the transport position by means of a locking unit.

The locking unit could, for example, be designed with one or more locking pawls of the type of a rotatable lever, wherein one locking pawl is assigned to each first end of a guide rod facing the exterior of the vehicle and/or the respective corresponding area of the guide rail, whereby an extension of the guide rod in the direction of the vehicle exterior is prevented. The pawls can particularly be actuated by means of a locking actuator via cables, preferably Bowden cables. The locking unit is intended to ensure that, during normal vehicle operation, that is, if the motor vehicle is moving by means of the wheel drive, the at least one rotary blade drive is secured in the transport position, and unintentional “shooting out” of the guide rod from the guide rail and, consequently, of the rotary blade drive is prevented to increase road safety.

For structural stability, it is also advantageous to arrange the guide rods running along the longitudinal direction of the vehicle (and the associated guide rails) in pairs, for example the pair of guide rods located on the inside with respect to the transverse direction of the vehicle carries the drive shaft and thus the weight of the motor vehicle by means of bearings, particularly pivot bearings, while the outer pair of guide rods, indirectly via the drive carrier, carries the rotary blade drive and thus supports the counter-torque of the transmissions.

According to an optionally provided embodiment of the lifting device according to the invention, at least one support device is firmly connected to the drive shaft and can be rotated with it about the axis of rotation, which enables additional support of the motor vehicle.

In an advantageous development, the support device has a support carrier arm and a support foot, wherein the support carrier arm is firmly connected to the drive shaft by means of a first end section and the support foot is pivotably articulated to a second end section of the support carrier arm.

Optionally, together with the at least one rotary blade drive, a support device can be rotated by means of a common drive shaft in the direction of the ground, in an orientation perpendicular to the vehicle underbody and supported on the ground, to additionally stabilize the motor vehicle. Preferably, the first end section of a support carrier arm can be connected to the drive shaft centrally between two rotary blades, and a support foot can be pivotably articulated to the second end section of the support carrier arm. Particularly in the case of very soft ground, which the supporting edge of the rotary blade would possibly sink into, the total supporting surface area is increased in this way and the lifting device is prevented from sinking into the soft ground. During normal vehicle operation, in the operating position of the motor vehicle, the support carrier arm is oriented parallel or horizontal to the vehicle underbody. The pivotable connection between the second end section of the support arm and the support foot is implemented, for example, by means of a fastening axis, such that the support foot assumes an equilibrium position when the support arm runs parallel to the vehicle underbody, that is, follows gravity, and also is oriented horizontally. In this position, the support foot can be secured by clamping elements to prevent rattling while driving.

According to a particularly advantageous further development of this embodiment, the support foot has a support foot upper part and a support foot base, wherein the support foot upper part is articulated to the second end portion of the support carrier arm and the support foot base is pivotably connected to a transverse edge of the support foot upper part.

Due to the pivotable connection, the support foot base can be pivoted from a position arranged next to the support foot upper part into a position resting on the underside of the support foot upper part and facing the ground. Such a pivotable connection can be implemented, for example, by means of a foot pivot gear with an associated foot pivot drive motor, wherein at least one rigid, non-rotatable tooth element is connected to both the support foot base and the support foot upper part. The tooth elements then roll off one another when the support foot base is pivoted relative to the support foot upper part. This makes it possible to place a support footrest designed as a profile plate with a very coarse traction pattern as flatly as possible and thus in a space-saving manner against the vehicle underbody during normal operation of the motor vehicle and at the same time to further increase the overall traction of the lifting device.

The different designs of the support device can either already be an integral part of the lifting device according to the invention or, if required, can be retrofitted by hand and also removed again.

In an optional variant of the lifting device, the support structure and the at least one rotary blade drive and/or the at least one support device can also be connected at an angle to save more space under the motor vehicle and/or to use the space available on the vehicle underbody in an as space-saving manner as possible

This particularly means that all components connected directly or indirectly to the guide rods, more precisely to the first ends of the guide rods facing the vehicle exterior, are arranged at an angle to the guide rods, the guide rails, and consequently to the support structure and the vehicle underbody. These components are preferably arranged higher up on the motor vehicle, either in front of the front axle or behind the rear axle. As a result, the ground clearance of these components is increased, such that the slope angle that can be overcome is also increased in ascending or hilly or mountainous terrain. The size of the included angle depends on the space available at the front or rear of the respective motor vehicle. The angle is preferably in a range between 15° and 60° and can particularly be 30°.

According to a preferred embodiment of the invention, at least one rotary blade and/or at least one rotary blade support and/or at least one stabilizing device and/or at least one support foot and/or at least one support foot base is formed with a traction pattern for resting on the ground to increase the friction or traction on particularly smooth surfaces such as ice or snow.

Basically not necessary for the functioning of the lifting device, but nevertheless useful in order to counteract contamination or damage, the rotary blade drive and/or the support device can be enclosed by a single or by separate, rigid or elastic protective cover(s), which allows their relative movement by means of an interface with the drive shaft. Since the guide rods and the components connected to them protrude far in front of and/or behind the motor vehicle in the drive position, it is advisable to install hazard warning lights at the respective outermost positions.

In addition to moving a motor vehicle, it is also conceivable to use the lifting device according to the invention in one of the variants described above for transporting or moving other loads.

The basic concept of the invention also includes a support device for a lifting device having a drive shaft, particularly for a lifting device according to one of the configurations described above, which is why independent protection is claimed therefor.

The support device has a support carrier arm and a support foot, which support carrier arm can be firmly connected to the drive shaft of the lifting device and/or the motor vehicle by means of a first end section and which support foot is pivotably articulated to a second end section of the support carrier arm. Particularly, the support foot has a support foot upper part and a support foot base, which support foot upper part is articulated to the second end section of the support carrier arm and which support foot base is pivotably connected to a transverse edge of the support foot upper part.

For example, it is conceivable to carry a support device according to the invention in the trunk or loading space and/or in the interior of a motor vehicle, and, if required, to attach it manually, on the drive shaft of the lifting device and/or the motor vehicle itself, e.g. before starting an off-road trip or even only when the motor vehicle has already got stuck.

Finally, the invention is directed to a motor vehicle with a lifting device according to any one of the embodiments described above, wherein a drive unit driving the at least one drive motor and/or the at least one linear actuator and/or other actuators can be arranged in a loading space and/or trunk and/or engine compartment of the motor vehicle, optionally also on the underbody or on the vehicle roof.

A control unit, which is provided for automatic control and readjustment or adjustment of the lifting device, can also be arranged within the motor vehicle, preferably within a loading space and/or trunk and/or engine compartment. Particularly, each rotary blade drive can be activated individually to enable, as required, the respective drive shafts and rotary blades to rotate in the same or opposite direction of rotation. It is therefore not necessary for the user or the vehicle occupants to get out of the vehicle.

### BRIEF DESCRIPTION OF THE VIEWS OF THE DRAWINGS

Further details, features, (sub)combinations of features, advantages, and effects based on the invention can be derived from the following description of preferred exemplary embodiments of the invention and the drawings. Wherein, schematically,

FIG. 1 shows a plan view of a first exemplary embodiment of a lifting device according to the invention with a support construction, two rotary blade drives and two support devices,

FIG. 2 shows a detailed perspective view of a rotary blade drive of an exemplary embodiment of a lifting device according to the invention,

FIG. 3 shows a perspective view of an exemplary embodiment of a lifting device according to the invention, wherein the rotary blade drive is extended into a drive position,

FIG. 4 shoes a detailed perspective view of an exemplary embodiment of a support device for a lifting device according to the invention,

FIG. 5 shows a perspective view of an exemplary embodiment of a spring lock,

FIG. 6 shows a perspective view of an exemplary embodiment of a lifting device according to the invention, wherein a rotary blade drive and a support structure are arranged at an angle to one another,

FIG. 7 shows a perspective view of an exemplary embodiment of a stabilization device,

FIG. 8 shows a perspective view of an exemplary embodiment of a lifting device according to the invention with a traction pattern,

FIG. 9 shows a perspective view of an exemplary embodiment of a lifting device according to the invention with a drive motor arranged in parallel,

FIG. 10 shows a perspective view of an exemplary embodiment of a lifting device according to the invention in a flatter design,

FIG. 11 shows a perspective view of an exemplary embodiment of a lifting device of the invention for peripheral attachment to the motor vehicle,

FIG. 12 shows a perspective view of the drive shaft and the drive motor of the embodiment of FIG. 11,

FIG. 13 shows a perspective view of the embodiment of FIG. 11 with two pivotably and adjustably formed rotary blades,

FIG. 14a shows a perspective view of a rotary blade which can be manually adjusted in length, and

FIG. 14b shows a perspective view of a rotary blade which can be adjusted in length by means of an actuator.

The figures are merely exemplary in nature and are only used for understanding the invention. Like elements are always provided with like reference numerals, which is why they are usually only described once. The embodiments shown are for the most part symmetrical with respect to their longitudinal and transverse axes. For the sake of clarity, elements that mirror on these axes are mostly identified only once by one reference numeral in the figures.

### DETAILED DESCRIPTION OF THE INVENTION

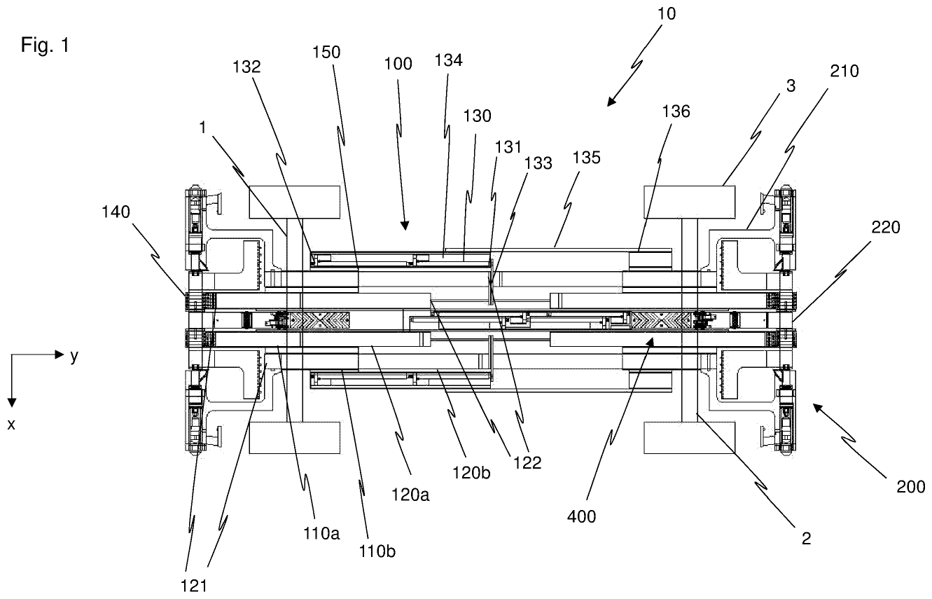

FIG. 1 shows a schematic representation of a first exemplary embodiment of a lifting device 10 according to the invention with a support structure 100, two rotary blade drives 200 and two support devices 400 from above, viewed from the motor vehicle in the direction of the ground. In addition, the vehicle front axle 1, the vehicle rear axle 2, and the vehicle wheels 3 are indicated schematically in FIG. 1 in order to enable a better understanding of the orientation and the size ratios. For each of the rotary blade drives 200, the support structure 100 comprises a pair of guide rails 110a located on the inside with respect to a vehicle transverse direction x and a pair of guide rails 110b located on the outside with respect to the vehicle transverse direction x, each of which running along a vehicle longitudinal direction y and can be permanently or removably connected to the vehicle underbody of the motor vehicle. Inside the guide rails 110a, 110b, there are guide rods 120a, 120b which can be linearly pushed back and forth in the vehicle longitudinal direction y. A first end 121 of an inner guide rod 120a is connected to a drive shaft 220 of the respective rotary blade drive 200 by means of a bearing 140, particularly a pivot bearing, such that the inner guide rods 120a carry the weight of the motor vehicle. Accordingly, the first ends 121 of the outer guide rods 120b are connected to a drive carrier 210 of the respective rotary blade drive 200, such that the outer guide rods 120b carry the respective rotary blade drive 200.

The guide rails 110a, 110b are designed as rectangular tubes in this embodiment, but can also take any other shapes, e.g. round tubes or T-beams, etc. To protect the guide rails 110a, 110b from dirt ingress and lubricant discharge, dirt stripping seals 150 can be arranged at each inlet and outlet of the rails.

Linear actuators 130 are provided for the linear movement of the guide rods 120a, 120b in the guide rails 110a, 110b. A first end section 131 of a linear actuator 130 is connected to a second end 122 of the guide rods 120a, 120b by means of a connecting rod 133. The connecting rods 133 also connect the inner guide rods 120a to the outer guide rods 120b and, optionally, connect the two connected pairs again to one another, such that such a unit of four guide rods 120a, 120b can be moved as a whole. A second end section 132 of a linear actuator 130 is connected to the respective guide rails 110a, 110b. In the simplest variant, a linear actuator 130 located on the inside with respect to the vehicle transverse direction x is provided for moving the rotary blade drive 200 assigned to the vehicle front axle 1, and two external linear actuators 130 are provided for moving the rotary blade drive 200 assigned to the vehicle rear axle 2. According to the present illustration, the linear actuators 130 can be arranged in linear actuator guide rails 134 in the event that additional guiding is necessary. This can be the case, for example, if, as shown here, multiple, preferably two, linear actuators 130 are arranged and connected in series in a linear actuator guide rail 134 to increase the travel distance and to protect against dirt and mechanical damage. The two linear actuators 130 could also be combined into an accordingly long, individual, particularly hydraulic or pneumatic linear actuator 130. In such an embodiment, the linear actuator guide rails 134 could then be eliminated. To precisely align the linear actuators 130 and their linear actuator guide rails 134 with the guide rods 120a, 120b to be moved, and to stabilize them against bending moments, the linear actuator guide rails 134 are connected by means of spacer connecting rods 135 to spacers 136 , which in turn are connected to the outer guide rails 110b.

In FIG. 1, the rotary blade drives 200 are each shown in a transport position in which the respective rotary blade drive 200 is arranged below the vehicle underbody. The rotary blade drives 200 can be extended via the support structure 100 by means of the associated guide rods 120a, 120b into a drive position in which the rotary blade drive 200 protrudes in front of or behind the motor vehicle. Depending on requirements, the rotary blade drive 200 assigned to the vehicle front axle 1 and the rotary blade drive 200 assigned to the vehicle rear axle can each be extended and/or retracted individually or together.

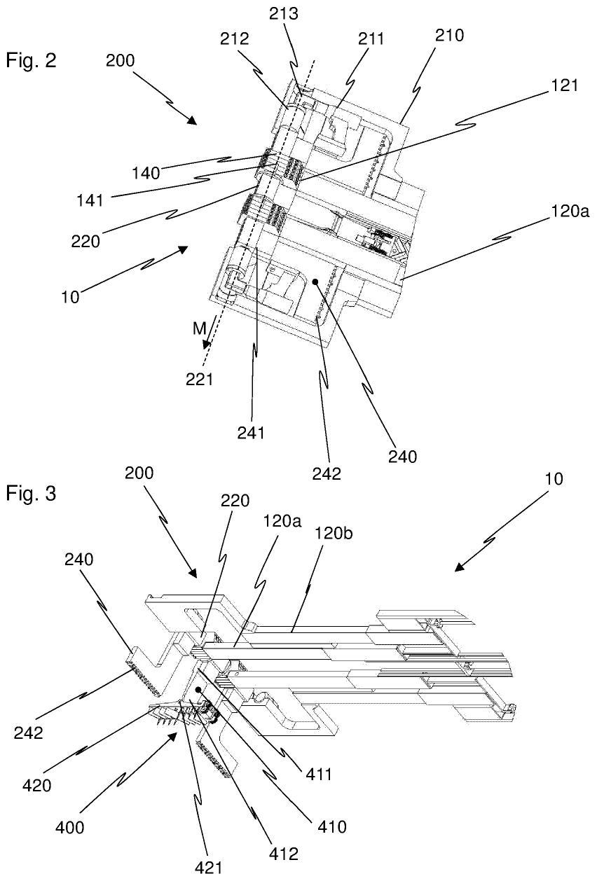

FIG. 2 shows a detailed perspective view of a rotary blade drive 200 of an exemplary embodiment of a lifting device 10 according to the invention in the transport position, viewed from the vehicle underbody in the direction of the ground. Drive motors 211 and reduction gears 212 are attached to the drive carrier 210, and their drive and output shafts are connected to one another. In contrast to what is shown in FIG. 1, the drive motors 211 in this embodiment are more space-saving, arranged at an angle of, for example, 90° to the reduction gear 212, and connected via an angular gear 213. The angular gear 213 directs the torque at the desired angle, in this case 90°, from the drive motor 211 to the reduction gear 212. The drive motors can use different physical drive principles and be electrical, pneumatic, hydraulic, etc., for example. The output shafts of the reduction gears 212 are positively seated in respective recesses in the drive shaft 220. The drive shaft 220 is shown here as a square shaft, but could also have other cross-sectional shapes, e.g. round. The bearings 140, such as roller or slide bearings, are arranged on two sections of the drive shaft 220. The drive shaft 220 can rotate about its axis of rotation 221 in these bearings 140 as often as desired. The bearings 140 sit in bearing supports 141, which in turn are connected to the first ends 121 of the inner guide rods 120a.

A rotary blade 240 is located between a bearing 140 and the drive carrier 210 and is firmly connected to the drive shaft 220 via a connecting section 241 arranged at a radially inner end, such that the rotary blade 240 can be rotated together with the drive shaft 220 and about the axis of rotation 221 thereof. The rotary blades 240 are each shown here in a retracted position and extend radially, parallel, or horizontally to the vehicle underbody, in the direction of a radially outer end on which a support edge 242 is arranged. If the drive shaft 220 is set in rotation, the rotary blades 240 rotate as well. As soon as these touch the ground, they begin to lift the motor vehicle from an operating position into an at least partially lifted position and at the same time pull or push it in the respective direction of rotation as a result of the torque M that acts along the axis of rotation 221.

In FIGS. 1 and 2, the lifting device 10 is shown as it takes up the smallest possible installation space during normal driving of the motor vehicle. Particularly, the rotary blade drives 200 are located in a transport position arranged below the vehicle underbody, and the rotary blades 240 are arranged in a retracted position running horizontally to the vehicle underbody.

FIG. 3 shows a perspective view of an exemplary lifting device 10 from below, viewed from the ground in the direction of the vehicle underbody. The lifting device 10 is shown here as it holds the motor vehicle in an at least partially lifted position. For this purpose, the rotary blades 240 are shown in an extended position and run perpendicular to the vehicle underbody or form an angle of approximately 90° with the vehicle underbody. Furthermore, the entire rotary blade drive 200 is also in the drive position in which the guide rods 120a, 120b are extended and the rotary blade drive 200 protrudes in front of or behind the vehicle underbody. This drive position is particularly necessary for moving the motor vehicle to enable the rotary blades 240 to rotate completely around the drive shaft 220 without them hitting, or getting stuck, on the vehicle underbody. To move the motor vehicle, the rotary blades 240 can rotate along a direction of rotation from the retracted position into the extended position, as a result of which the motor vehicle is lifted and pulled or pushed and/or displaced relative to the ground. The rotary blades 240 then continue to rotate along the same direction of rotation back into the retracted position until a 360° rotation is completed. At the same time, the motor vehicle is pushed or pulled further and, offset by a respective distance, touches down again on its vehicle wheels 3. This process can be repeated any number of times in order to move the motor vehicle along any distance.

In order to increase the traction of the rotary blades 240, particularly on smooth surfaces such as black ice or snow, they have a corrugated structure and/or spike-like tips on their support edge 242, which can also “claw” into hard surfaces. For particularly soft surfaces, as shown here, a support device 400 can be arranged as an option between the two rotary blades 240. According to FIG. 3, the support device 400 is also in an extended position in which a support carrier arm 410 extends perpendicular to the vehicle underbody. The support carrier arm 410 is firmly connected to the drive shaft 220 via a first end section 411 and is rotatable about its axis of rotation 211. A support foot 420 is articulated to a second end section 412 such that it can rotate about a fastening axis 421, such that the support foot 420, following the force of gravity, assumes a horizontal orientation relative to the ground.

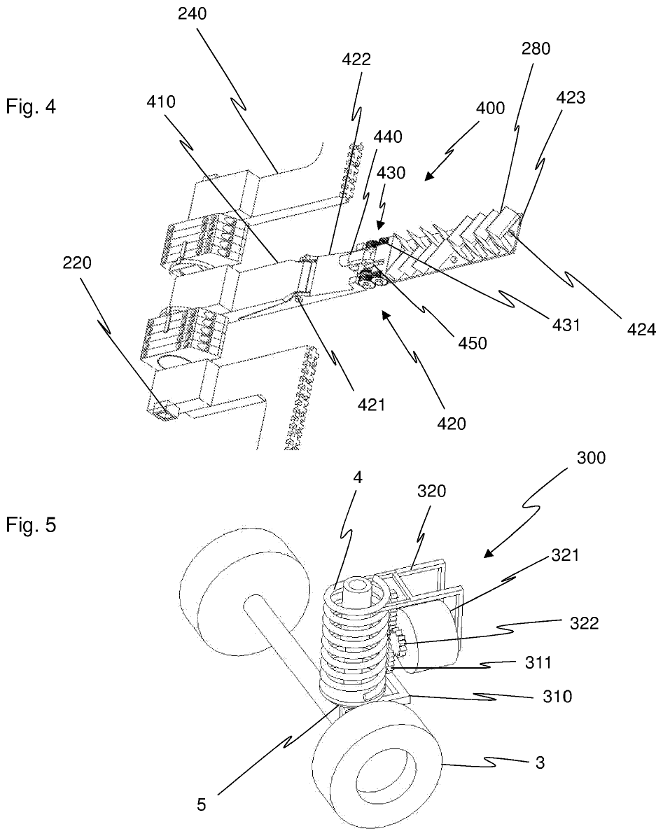

In the detailed perspective view according to FIG. 4, the support device 400 is shown from above, viewed from the vehicle underbody in the direction of the ground, in a retracted position running horizontally relative to the vehicle underbody. In this position, the support foot 420 is pivoted about the fastening axis 421 and forms an extension of the support carrier arm 410. It can be clearly seen that the support foot 420 is designed in two parts and comprises a support foot upper part 422 and a support foot base 423, which in the retracted position are arranged adjacent to one another and as flat as possible on the vehicle underbody to save space. To pivot the support foot base 423 in the extended position of the support device 400 into a position below the support foot upper part 422 (see FIG. 3), a swivel arm 450 can be rotated by means of a pivot drive motor 440 about an axis which runs between two round toothed elements 431 of a support foot pivot gear 430. The other end of the swivel arm 450 runs rotatably through the axis which connects the two toothed elements 431 attached to the support foot base 423, such that they roll over one another when the support foot base 423 is pivoted. The support foot base 423 also has a traction pattern 280 intended to rest on the ground as well as retaining bolts 424 protruding on the opposite side in order to fix the support foot base 423 in complementary mating openings of the support foot upper part 422. As a result, the force that is transmitted to the support foot base 423 by the support foot upper part 422 is not conducted via the support foot pivoting gear 430, which is thus protected. To travel through the large angular range in which neither the rotary blades 240 nor the support foot bases 423 contact the ground in a short time, but at a low torque when the drive shaft 220 rotates, a gear change actuator can be provided which, in the no-load condition, moves into a higher gear and switches back into a low working gear shortly before contacting the ground.

A schematic perspective view of a spring lock 300 can be seen in FIG. 5. The spring lock 300 can be attached, for example, to the shock absorber spring 4 of a vehicle wheel 3 to prevent rebounding and thereby to increase the achievable height to which the motor vehicle can be lifted. A toothed rack carrier 310, to which a toothed rack 311 is attached, is attached to the spring plate 5 connected to the wheel suspension. A motor support 320 with a servomotor 321, on the other hand, is connected to the shock absorber spring 4. The servomotor 321 is in turn connected by means of its drive shaft to a servomotor gear wheel 322 which engages in the teeth of the toothed rack 311. In the no-load state, the servomotor 321 is rotated by the rack 311 which is moved up and down due to unevenness in the ground. A load can be applied to the servomotor 321 and thereby lock the shock absorber spring 4 or even actively compress it to prevent the vehicle wheels 3 from rebounding when the motor vehicle is lifted.

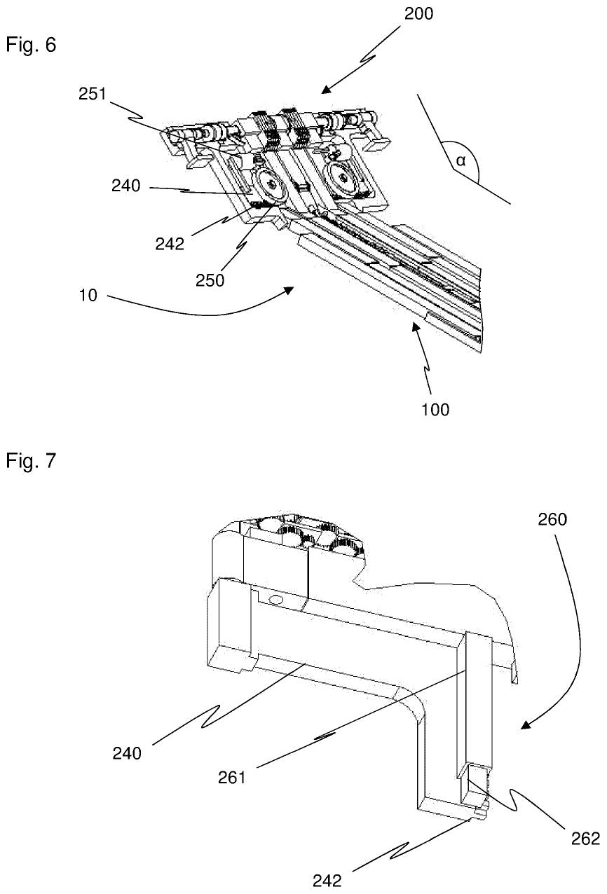

FIG. 6 also shows a perspective view of an exemplary embodiment of a lifting device 10 according to the invention from above, viewed from the vehicle underbody towards the ground. The rotary blade drive 200 shown and the support structure 100 are arranged here forming an angle α with one another. The angular arrangement makes it possible to increase the distance between the rotary blade drive 200 and the ground. The size of the angle α depends on the space below the motor vehicle that is available in front of the vehicle front axle 1 or behind the vehicle rear axle 2. The larger the angle α, the larger the slope angle that the motor vehicle can climb or overcome in the terrain. FIG. 6 still shows another optional embodiment variant, in which the rotary blades 240 each have a transverse wheel 250 on their supporting edge 242, the axis of rotation of which is perpendicular to the axis of rotation of the vehicle wheels 3. The transverse wheels 250 protrude beyond the support edge 242 of the respective rotary blade 240, such that the transverse wheels 250 can roll on the ground in the extended position of the rotary blades 240 (not shown here). Each transverse wheel 250 is assigned a transverse wheel drive 251, which enables the respective transverse wheel 250 to rotate in two directions of rotation. For example, the motor vehicle can be rotated about its vertical axis by rotating the transverse wheels 250 assigned to a vehicle front axle 1 in one direction of rotation and the transverse wheels 250 assigned to a vehicle rear axle 2 in an opposite direction of rotation. The motor vehicle can be moved sideways if all transverse wheels 250 rotate in the same direction of rotation.

A stabilization device 260, which can optionally be arranged on a support edge 242 of a rotary blade 240, can be seen in the perspective view according to FIG. 7. The stabilization device 260 comprises a stabilization carrier 261 with an internal linear actuator which can extend a stabilization rod 262 laterally along the support edge 242 of the respective rotary blade 240 or along the vehicle transverse direction x. In the extended state (not shown here), the support edge 242 is consequently extended by the stabilizing rod 262, such that the motor vehicle is stabilized against lateral tilting in the lifting position.

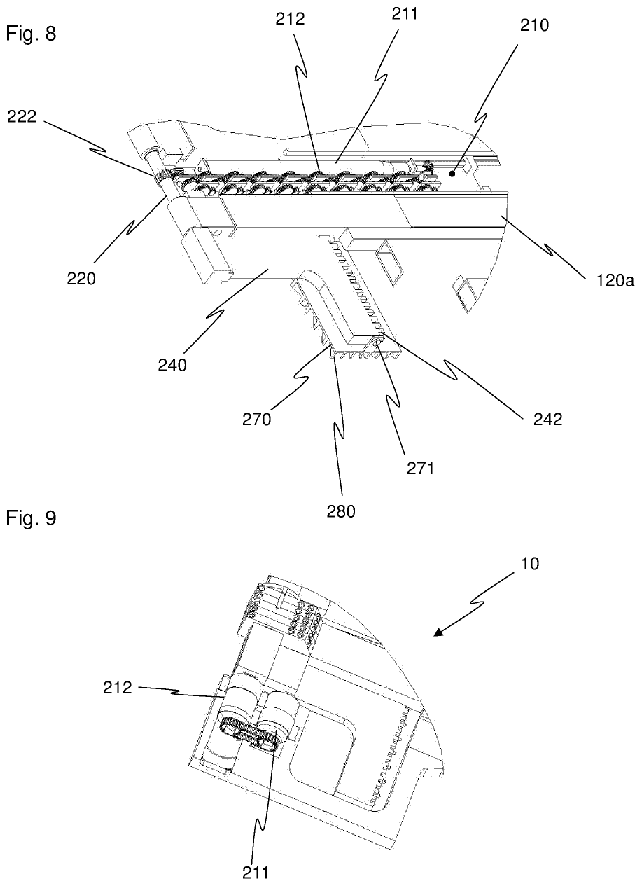

According to the perspective detailed view from FIG. 8, the support edge 242 of a rotary blade 240 can additionally or optionally be connected to a pivotably attached rotary blade support 270. The rotary blade support 270 is provided to increase the traction on particularly soft ground and, due to the connection implemented pivotably by means of a joint 271, automatically aligns itself with the support on the ground, following the force of gravity. The rotary blade support 270 is also provided with a traction pattern 280. Furthermore, FIG. 8 shows another embodiment variant in which the drive carrier 210, the drive motor 211, and the reduction gear 212 are arranged between the inner guide rods 120a. The drive carrier 210 is also fastened to the inner guide rods 120a, as a result of which the outer guide rods 120b (see FIG. 1) can be eliminated. The drive shaft 220 is firmly connected to a drive shaft gear 222, on which the reduction gear 212 can engage either with a gear output gear wheel or with a drive chain to transmit the torque. In this embodiment, it is advantageous that the rotary blades 240 can be made wider in order to better stabilize the motor vehicle against tipping in the at least partially raised lifting position.

FIG. 9 shows a perspective view of an exemplary embodiment of a lifting device 10 according to the invention with a drive motor 211 arranged laterally parallel to the reduction gear 212. The drive motor 211 and the reduction gear 212 are connected in the torque flow by means of a chain, which is why the drive shaft of the drive motor 211 and the input shaft of the reduction gear 212 each comprise a sprocket. Due to the parallel arrangement, additional space can be saved overall and the width of the drive carrier 210 can be reduced.

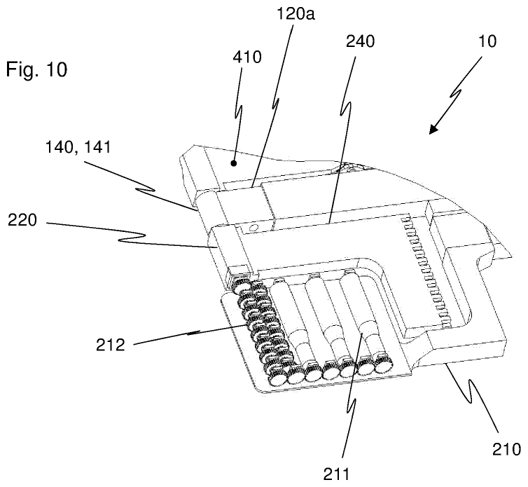

As a rule, vehicles have more ground clearance under the front and rear bumpers or under the front engine area or the rear trunk area than, for example, between the vehicle axles 1, 2. The drive supports 210 with their drive motors 211 and reduction gears 212 of the embodiments described above are placed in the area of higher ground clearance, which thereby do not further restrict the ground clearance of the motor vehicle despite their greater thickness than that of the other components of the lifting device 10. For motor vehicles that do not have this higher ground clearance or to increase the insurmountable slope angle, the perspective view of FIG. 10 shows another exemplary embodiment of a lifting device 10 according to the invention in a flatter design. The drive supports 210 are just as flat here as the other components of the lifting device 10, in that the drive motors 211 and the reduction gears 212 are of a flatter design. In this way, the drive supports 210 can be placed at any desired positions below the vehicle underbody. Optionally, two or more drive motors 211 can be arranged in parallel next to one another and connected via associated gears to increase the power and the torque. To make the drive shaft 220 flatter as well, it is conceivable to integrate the rotary blades 240 and the support carrier arm 410 into the drive shaft 220 or to form them in one piece. Accordingly, the bearing support 141 of the bearing 140 can also be integrated into the guide rods 120a.

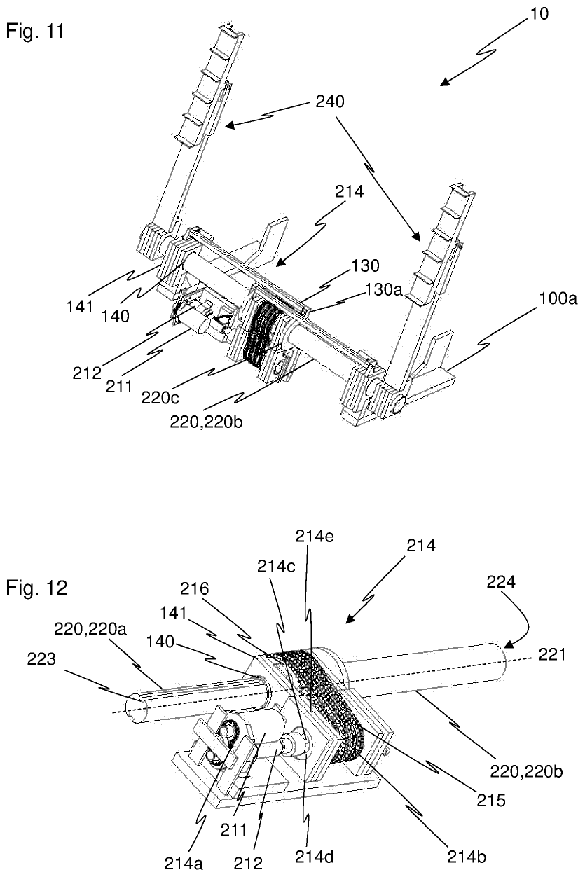

FIG. 11 shows a perspective view of another exemplary embodiment of the lifting device 10 according to the invention for peripheral fastening to the motor vehicle, preferably to the vehicle underbody. In the assembled state of the lifting device 10, the support structure 100a runs parallel to the vehicle underbody and is fixedly or removably connected thereto, particularly to the longitudinal members of the vehicle underbody, or to other components of the motor vehicle. At the respective peripheral ends of the support structure 100a, bearings 140 are mounted in bearing supports 141, in which bearings the drive shaft 220 is both rotatably and movably supported. The bearings 140 thus serve both as radial bearings and as axial guides for the drive shaft 220. The lifting device 10 shown is shown in a transport position, with the drive shaft 220 in the assembled state in front of or behind the motor vehicle and the rotary blades 240, which are firmly connected for torque transmission to the axial ends of the drive shaft 220, point perpendicular to the support structure 100a in the direction of the vehicle roof\

To enable axial movement of the rotary blades 240 into a position protruding beyond the lateral dimensions of the motor vehicle, the drive shaft 220 is configured as an inner shaft 220a, not visible in FIG. 11, coaxially surrounded by two adjacent hollow shafts 220b, wherein each hollow shaft 220b is firmly connected at its axially outer end to a rotary blade 240. A flange-like sliding disk 220c, which represents a first force application point for at least one respective linear actuator 130, is arranged on the axially inner ends of the hollow shafts 220b. The linear actuator 130 forms a sliding contact with the sliding disk 220c by means of a clamp 130a, such that axial transmission of force is made possible without impeding the rotation of the sliding disk 220c and the hollow shaft 220b connected thereto. The second force application point for the linear actuator 130 must be provided on an immovable, rigid component, for example on the bearing supports 141. In the transport position of the lifting device 10, in which the rotary blades 240 should not protrude beyond the lateral dimensions of the motor vehicle, the hollow shafts 220b in the retracted position of the rotary blades are each pushed over the inner shaft 220a, which is not visible for this reason.

A drive motor 211 is either directly axially aligned or connected indirectly, for example via a toothed wheel, toothed belt drive, chains or a V-belt to an input shaft of a reduction gear 212. The drive shaft 220 can be set in rotation via the reduction gear 212 by means of the drive motor 211, which is arranged axially offset in this embodiment. The drive motor 211 and the reduction gear 212 are part of a torque booster unit 214. To prevent the torque booster unit 214 from rotating itself due to its own counter-torque after activation of the drive motor 211, it is supported, preferably via fastening elements (not shown here), on non-movable, rigid parts of the motor vehicle (e.g. on the trailer coupling, the bumper, etc.) or on the support structure 100a.

A detailed perspective illustration of the torque booster unit 214 can be seen in FIG. 12. To rotate the drive shaft 220 about its axis of rotation 221, the drive motor 211 which is connected to the reduction gear 212 via the motor gear chain 214a transmits its torque to the drive sprockets 214b, which in turn drive the inner shaft drive sprockets 216 connected to the inner shaft 220a by means of drive chains 215. FIG. 12 also shows the inner shaft 220a arranged coaxially within the hollow shaft 220b. The inner shaft 220a is rotatably seated in a bearing 140 with an associated bearing support 141. The bearing supports 141 of the inner shaft 220a are preferably each arranged axially adjacent to the inner shaft drive ring gear 216 to reduce deformations on force-carrying components due to bending levers that are too long. A drive sprocket carrier shaft 214c connected to the gear output of the reduction gear unit 212 and carrying the drive sprockets 214b runs in drive sprocket carrier shaft bearings 214d. The drive sprocket carrier shaft bearings 214d are in turn held axially and radially in non-rotatable drive sprocket carrier shaft bearing carriers 214e. To absorb the tensile forces of the drive chain 215, the drive sprocket carrier shaft bearing supports 214e are also firmly connected to the adjacent bearing supports 141. There is a torque-transmitting operative connection between the inner shaft 220a and the respective hollow shaft 220b in that the inner shaft 220a has at least one, in this case two, longitudinal grooves 223, and the hollow shafts 220b have complementary, radially inner longitudinal struts 224. As a result of this form-fitting seat, the hollow shafts 220b can be moved axially on the inner shaft 220a, but cannot be rotated about it.

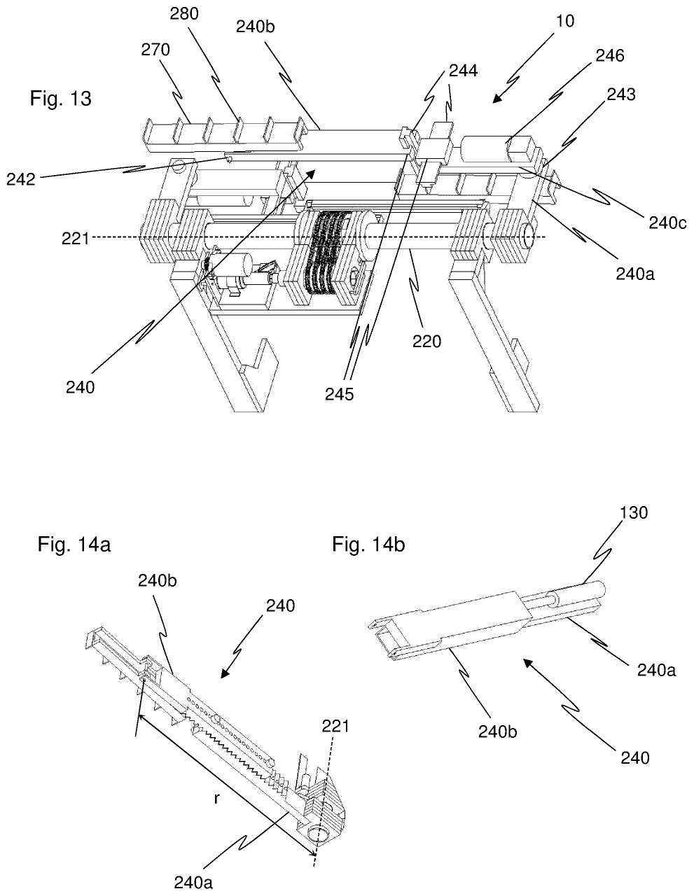

FIG. 13 shows a perspective view of the embodiment of a lifting device 10 according to FIG. 11 with two rotary blades 240 which are each configured to be pivotable and adjustable. Each rotary blade 240 includes a radially inner rotary blade arm 240a, a radially outer rotary blade arm 240b, and an intermediate rotary blade arm portion 240c. The designations radially inside or radially outside each refer to a radius the origin of which lies on the axis of rotation 221 of the drive shaft 220. The radially inner rotary blade arm 240a is firmly connected to the respective hollow shaft 220b; the radially outer rotary blade arm 240b has a pivotably articulated rotary blade support 270 with a traction pattern 280 at its radially outer end 242. Furthermore, the radially inner rotary blade arm 240a is connected to the rotary blade arm section 240c via a rotary joint 243. By means of a swivel motor 246, the radially inner rotary blade arm 240a and the rotary blade arm section 240c can be rotated relative to one another about the rotary joint 243. In the present illustration, the rotary blade 240 is shown retracted into a transport position parallel to the drive shaft 220. The rotary blade arm section 240c is also connected to the radially outer rotary blade arm 240b via two guide rails 244 and respective associated guide slides 245, as a result of which the rotary blades 240 can be aligned offset to one another in two additional spatial directions. In the transport position of the lifting device 10 shown, both rotary blades 240 are pivoted into a position running parallel to the drive shaft 220 and are arranged offset to one another with respect to the vehicle longitudinal direction y.

FIGS. 14a and 14b each show a perspective view of an embodiment in which the rotary blade 240 shown is adjustable in its radial length r (starting from the axis of rotation 221). The respective rotary blade 240 comprises a radially inner rotary blade arm 240a and a radially outer rotary blade arm 240b, which are radially displaceable relative to one another to adjust the radial length r of the rotary blade 240 as required. According to FIG. 14a, the rotary blade arms 240a, 240b are each provided with mutually facing and complementary corrugated profiles for manual adjustment, which allow a positive, mutual hooking of the rotary blade arms 240a, 240b in evenly spaced positions. Furthermore, the rotary blade arms 240a, 240b are penetrated by evenly spaced bores, through which bolts or screws can pass, for example, in order to fix the rotary blade arms 240a, 240b in the desired position. According to FIG. 14b, the radial length r of the rotary blade 240 can be adjusted by an actuator using a linear actuator 130. The radially outer rotary blade arm 240b additionally has a guide rail in which the radially inner rotary blade arm 240a can slide back and forth.

The design variants shown and/or described individually in the figures described above can be combined with one another in any meaningful way in order to adapt the lifting device 10 according to the invention to the respective application as required and/or desired.

### LIST OF REFERENCE NUMERALS

1 vehicle front axle

2 vehicle rear axle

3 vehicle wheel

4 shock absorber spring

5 spring plate

10 lifting device

100, 100a support structure

110a inner guide rail

110b outer guide rail

120a inner guide rod

120b outer guide rod

121 first end of the guide rod

122 second end of the guide rod

130 linear actuator

130a clamp

131 first end section of the linear actuator

132 second end section of the linear actuator

133 connecting rod

134 linear actuator guide rail

135 spacer connecting rod

136 spacer

140 bearing

141 bearing support

150 seals

200 rotary blade drive

210 drive carrier

211 drive motor

212 reduction gear

213 angular gear

214 torque amplifier unit

214a motor gear chain

214b drive sprockets

214c drive sprocket carrier shaft

214d drive sprocket carrier shaft bearing

214e drive sprocket carrier shaft bearing support

215 drive chain

216 inner shaft drive sprockets

220 drive shaft

220a inner shaft

220b hollow shaft

220c sliding disk

221 axis of rotation

222 drive shaft gear

223 longitudinal groove

224 longitudinal strut

240 rotary blade

240a radially inner rotary blade arm

240b radially outer rotary blade arm

240c rotary blade arm section

241 radially inner end, connecting section

242 radially outer end, support edge

243 swivel joint

244 guide rail

245 guide slide

246 swivel motor

250 transverse wheel

251 transverse wheel drive

260 stabilization device

261 stabilization carrier

262 stabilization rod

270 rotary blade support

271 joint

280 traction pattern

300 spring lock

310 toothed rack carrier

311 toothed rack

320 motor support

321 servomotor

322 servomotor gear

400 support device

410 support carrier arm

411 first end portion of the support carrier arm

412 second end portion of the support carrier arm

420 support foot

421 fastening axis

422 support foot upper part

423 support foot base

424 retaining bolt

430 support foot pivoting gear

431 tooth elements

440 pivot drive motor

450 swivel arm

M torque

y vehicle longitudinal direction

x vehicle transverse direction

r radial length of the rotary blade

αangle

1. A lifting device (10) for moving a motor vehicle with
a support structure (100, 100a) which is suitable to be removably or firmly connected to the motor vehicle, and
at least one drive shaft (220) which is rotatably mounted on the support structure (100, 100a),
characterized in that
the at least one drive shaft (220) is part of a rotary blade drive (200), wherein the lifting device has at least one rotary drive (200), each rotary blade drive (200) furthermore having at least one drive motor (211) for rotating the drive shaft (220) about the axis of rotation (221) thereof, and at least one rotary blade (240), wherein the rotary blade (240) is rotatably connected to the drive shaft (220) about the axis of rotation (221) such that the rotary blade (240) can be supported on a ground and the motor vehicle can be lifted and/or or moved as a result of a torque (M) acting along the drive shaft (220).

2. (canceled)

3. The lifting device (10) according to claim 1,
characterized in that
the at least one rotary blade (240) has a radially inner rotary blade arm (240a) assigned to the drive shaft (220) and a radially outer rotary blade arm (240b) assigned to the ground, wherein the radially inner rotary blade arm (240a) and the radially outer rotary blade arm (240b) are pivotally interconnected, such that the at least one rotary blade (240) can be pivoted from a retracted position running parallel to the drive shaft (220) into an extended position forming an angle with the drive shaft (220), preferably running perpendicular to the drive shaft (220).

4. The lifting device (10) according to claim 3,
characterized in that
the at least one rotary blade (240) has a radially inner rotary blade arm (240a) assigned to the drive shaft (220) and a radially outer rotary blade arm (240b) assigned to the ground, as well as a rotary blade arm section (240c) having one or more guide rails (244) with associated guide slides (245), such that an offset of the radially inner rotary blade arm (240a) relative to the radially outer rotary blade arm (240b) can be adjusted.

5. (canceled)

6. The lifting device (10) according claim 1,
characterized in that
the lifting device (10) has at least one rotary blade drive (200), wherein each rotary blade drive (200) is connected to the support structure (100, 100a) by means of a respective drive shaft (220) and a front rotary blade drive (200) of a vehicle front axle (1) or a rear rotary blade drive (200) are assigned to a vehicle rear axle (2).

7. The lifting device (10) according claim 6,
characterized in that
each drive shaft (220) has at least one rotary blade (240), preferably two rotary blades (240).

8. (canceled)

9. The lifting device (10) according to claim 7,
characterized in that
a stabilization device (260) is arranged on one, multiple, or all rotary blades (240), which device is provided for the lateral stabilization of the motor vehicle.

10. The lifting device (10) according to claim 7,
characterized in that
a rotary blade support (270) is arranged on one, multiple, or all rotary blades (240) and can be pivoted about a support edge (242) of the rotary blade (240).

11. The lifting device (10) according to claim 1,
characterized in that
one, multiple, or all rotary blades (240) have a radially inner rotary blade arm (240a) assigned to the drive shaft (220) and a radially outer rotary blade arm (240b) assigned to the ground, wherein the radially inner rotary blade arm (240a) and the radially outer rotary blade arm (240b) are radially displaceable relative to one another, whereby the radial length (r) of the respective rotary blade (240) can be adjusted.

12. The lifting device (10) according claim 1,
characterized in that
the support structure (100, 100a) has guide rails (110a, 110b) and guide rods (120a, 120b) that can be moved relative to one another along the longitudinal direction (y) of the vehicle, wherein the guide rails (110a, 110b) are suitable for a removable or fixed connection to the underbody of the motor vehicle, on the front of the vehicle, on the rear of the vehicle, on the vehicle roof or on the hood or optionally within the vehicle interior or trunk and the guide rods (120a, 120b) are connected to the at least one rotary blade drive (200).

13. The lifting device (10) according to claim 12,
characterized in that
the guide rails (110a, 110b) and the guide rods (120a, 120b) are connected to at least one linear actuator (130) for movement relative to one another and along the vehicle longitudinal direction (y), wherein a first end section (131) of the at least one linear actuator (130) is connected to a guide rod (120a, 120b) and a second end section (132) of the at least one linear actuator (130) is connected to a guide rail (110a, 110b).

14. The lifting device (10) according to claim 6,
characterized in that
the drive shaft (220), for axially moving the at least one rotary blade (240) along the axis of rotation (221) thereof, comprises an inner shaft (220a) connected to the drive motor (211) and at least one hollow shaft (220b) connected to the at least one rotary blade (240) and coaxially surrounding the inner shaft (220a), wherein the inner shaft (220a) and the hollow shaft (220b) are movable relative to one another along the axis of rotation (221) and are in a torque-transmitting operative connection with one another.

15. The lifting device (10) according to claim 12,
characterized in that
the guide rails (110a, 110b) and the guide rods (120a, 120b) can be locked in a transport position by means of a locking unit.

16. The lifting device (10) according to claim 6,
characterized by
at least one support device (400) which is firmly connected to the drive shaft (220) and can be rotated together with it about the axis of rotation (221) for additional support of the motor vehicle.

17. The lifting device (10) according to claim 16,
characterized in that
the support device (400) has a support carrier arm (410) and a support foot (420), wherein the support carrier arm (410) can be firmly connected to the drive shaft (220) via a first end section (411) and the support foot (420) can be pivotably articulated to a second end section (412) of the support carrier arm (410).

18. The lifting device (10) according to claim 17,
characterized in that
the support foot (420) has a support foot upper part (422) and a support foot base (423), wherein the support foot upper part (422) is articulated to the second end section (412) of the support carrier arm (410) and the support foot base (423) is pivotably connected to the support foot upper part (422).

19. (canceled)

20. The lifting device (10) according to claim 7,
characterized in that
at least one rotary blade (240) or at least one rotary blade support (270) or at least one stabilizing device (260) or at least one support foot (420) or at least one support foot base (423) is formed with a traction pattern (280) for resting on the ground.

21. A support device (400) for a lifting device (10) having a drive shaft (220), according to claim 6,
characterized in that
the support device (400) has a support carrier arm (410) and a support foot (420), which support carrier arm (410) can be firmly connected to the drive shaft (220) via a first end section (411) and which support foot (420) is articulated to a second end section (412) of the support carrier arm (410), wherein the support foot (420) particularly has a support foot upper part (422) and a support foot base (423), which support foot upper part (422) is articulated to the second end section (412) of the support carrier arm (410) and which support foot base (423) is pivotally connected to the support foot upper part (422).

22. A motor vehicle with a lifting device (10) according to claim 1,
characterized in that
a drive unit driving the at least one drive motor (211) and/or or the at least one linear actuator (130) and/or or other actuators can be arranged in a loading space and/or or trunk and/or or engine compartment of the motor vehicle.

23. A motor vehicle lifting device (10) according to claim 22,
characterized in that
the lifting device (10) is positioned on the front of the vehicle, on the rear of the vehicle, on the vehicle roof or on the hood, in a space-saving manner under the vehicle underbody or optionally within the vehicle interior or trunk.

24. The lifting device (10) according to claim 14,
characterized in that
the inner shaft (220a) and the hollow shaft (220b) can be locked in a transport position by means of a locking unit.
